(19) United States
(12) Patent Application Publication
(10) Pub. No.: US 2020/0188873 A1
(43) Pub. Date: Jun. 18, 2020

(54) Nanometal oxide Adsorbents for Desulfurization of Hydrocarbon Fuels

(71) Applicant: Advanced Energy Materials, LLC, Louisville, KY (US)

(72) Inventors: Mahendra Sunkara, Louisville, KY (US); Sivakumar Vasireddy, Louisville, KY (US); Juan He, Louisville, KY (US)

(21) Appl. No.: 16/481,714

(22) PCT Filed: Feb. 8, 2018
(86) PCT No.: PCT/US18/17355

§ 371 Date: Jul. 29, 2019

Related U.S. Application Data
(60) Provisional application No. 62/457,695, filed on Feb. 10, 2017.

(51) Int. Cl. B01J 20/06; B01J 20/08; B01J 20/12; C10G 25/00; C10G 29/04; C10G 29/16; B01J 20/28; B01J 20/30; B01J 23/755; B01J 23/883; B01J 35/00; B01J 37/08

(52) U.S. Cl. CPC B01J 20/06; C10G 2300/202; B01J 20/12; C10G 25/003; C10G 29/04; C10G 29/16; B01J 20/28007; B01J 20/28023; B01J 20/3085; B01J 20/3078; B01J 23/755; B01J 23/883; B01J 35/0013; B01J 37/08; B01J 20/08

(57) ABSTRACT

The present development is a new approach for deep desulfurization by adsorption of for removing sulfur using a solid adsorbent under atmospheric pressure and elevated temperatures from liquid fuels such as diesel, waste lube oil without using hydrogen. The adsorbent comprises metal particles from a group of Ni, Pt, Co, Mo and Cu deposited on MOₓ nanowires (M=Zn, Fe and Mn).

### CROSS-REFERENCE TO PRIOR APPLICATIONS

The present application claims priority to U.S. Patent Application 62/457,695 filed 2017 Feb. 10, currently pending, which is incorporated by reference in its entirety.

### GOVERNMENT INTEREST

This invention was made without government support.

### FIELD OF THE INVENTION

The present invention relates to the production of nanometal oxide adsorbents and the process for removal of sulfur from hydrocarbon fuels in a vapor phase fixed bed reactor. In particular, the disclosure relates to adsorbent compositions that make use of metal oxide nanowires that include catalytically active metal particles.

### BACKGROUND OF THE INVENTION

Sulfur compounds in liquid hydrocarbon fuels can oxidize to SOₓ species and cause air pollution. Various regulations now mandate lowering the sulfur levels in motor fuels, such as gasoline and diesel, to less than 10 ppm. However, the removal of sulfur compounds from the hydrocarbon feedstock can provide a challenge in petroleum refining. For example, refractory thiophenic sulfur compounds are particularly difficult to remove. The prior art method requires catalytic hydrodesulfurization process (HDS) in a trickle bed reactor operated at elevated temperatures (300-400° C.) and pressures (20-100 atm, H₂) using Co—Mo/Al₂O₃ and Ni—Mo/Al₂O₃ catalysts. The HDS process is effective in removing thiols, sulfides, and disulfides, but less efficient for thiophenes and thiophene derivatives. Thus, the sulfur compounds that remain in the transportation fuels are mainly thiophene, benzothiophene (BT), dibenzothiophene (DBT), and their alkylated derivatives. Moreover, the HDS process emits H₂S gas which requires further downstream processing to eventually converted the H₂S gas to elemental sulfur.

Polishing processes, such as reactive adsorption, selective adsorption, oxidation/extraction desulfurization, or ultrasonic desulfurization, may be used to supplement the conventional HDS process. Oxidation/extraction desulfurization has undesirable side reactions that reduce the quality and quantity of the fuel. Adsorption processes are attractive because of the straightforward operating conditions and availability of inexpensive and re-generable. However, only a few adsorbents have shown high selectivity for difficult to hydrotreat sulfur compounds.

Thus, it would be beneficial to have an adsorbent for removal of thiophenic sulfur from liquid fuels. It would be particularly beneficial to have an adsorbent for removal of thiophenic sulfur from liquid fuels that does not require the addition of hydrogen in a vapor phase fixed bed reactor at atmospheric pressure. Optimally, the liquid fuel may comprise diesel fuel, transmix fuels, re-refined waste lube oil or a combination thereof.

### SUMMARY OF THE PRESENT INVENTION

The present development is an adsorbent for removal of thiophenic sulfur from liquid fuels. The adsorbent consists of zinc oxide nanowires or iron oxide nanowires or manganese oxide nanowires decorated with catalytically-active metals selected from the group consisting of nickel, cobalt, molybdenum, platinum, palladium, copper and a combination thereof. The adsorbents of the present invention are intended for use in the removal of thiophenic sulfur from liquid fuels through a desulfurization process in a fixed bed reactor with no external hydrogen supply. The process reduces the sulfur concentration in the liquid fuel from about 1300 ppm by weight to approximately 15 ppm by weight without generating undesirable H₂S gas.

### BRIEF DESCRIPTION OF THE FIGURES

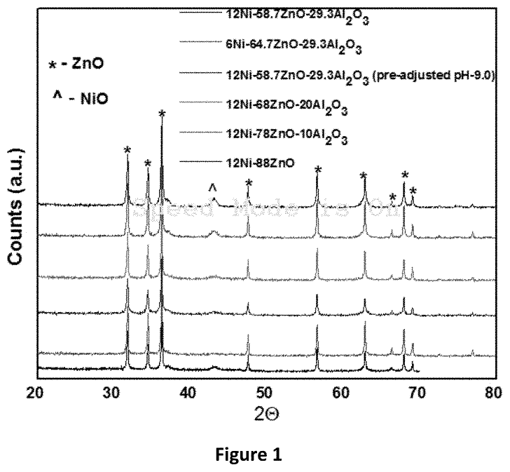

The FIG. 1 is a graph showing the X-ray diffraction patterns of some representative adsorbents.

### DETAILED DESCRIPTION OF THE PRESENT DEVELOPMENT

The present development is a catalyst composition and method for desulfurization of liquid fuel feedstock. The catalyst composition is an adsorbent comprising a metal oxide nanowire decorated with catalytically-active metal particles. The resulting catalyst may be used in the desulfurization process in oil refining processes. As used herein, the term “catalyst(s)” may be used interchangeably with the term “adsorbent(s)” when referring to the inventive composition.

The catalyst composition or adsorbent is prepared by loading catalytically-active metal particles onto metal oxide nanowires. Exemplary catalytically-active metals include nickel, cobalt, molybdenum, platinum, copper and combinations thereof. The metal oxide nanowire preferably comprises zinc oxide, iron oxide, manganese oxide, γ-alumina, or a combination thereof.

A preferred method for the production of zinc oxide nanowires is taught by Sunkara et al. in US Published Application 2012/0027955, which is incorporated herein in its entirety by reference. Iron oxide nanowires and manganese oxide nanowires may be synthesized by thermal oxidation of iron metal or manganese metal, respectively, techniques that are known in the art. Preferred temperatures for thermal oxidation range from 700° C. to 800° C. for a period of from about 2 hours to about 8 hours. In a most preferred embodiment the thermal oxidation is performed at about 750° C. for about 4 hours. It is anticipated that the metal oxide nanowire may comprise zinc oxide, iron oxide, manganese oxide, γ-alumina, or a combination thereof. In a preferred embodiment, the metal oxide nanowire comprises from about 55 wt % to about 88 wt % of the adsorbent composition.

Catalytically-active metals, are loaded onto the metal oxide nanowires via wet impregnation or incipient wetness techniques, as is known in the art. In a preferred embodiment, the adsorbents are prepared by conventional impregnation techniques using aqueous solution of metal nitrates or acetates. Exemplary catalytically-active metals include nickel, cobalt, molybdenum, platinum, palladium, copper and combinations thereof. The catalytically-active metal may be in the form of an elemental metal or an oxide. Without being bound by theory, it is believed that the catalytically-active metals are present on the surface of the nanowires as particles. Representative examples of catalytically-active metals on a nanowire support include, but are not limited to Ni/ZnO, Ni—Cu/ZnO, Ni/Fe₂O₃, Ni/MnO₂, Ni—Co/ZnO, Ni—Mo/ZnO, Ni—Pt/ZnO, Ni—Pt/Fe₂O₃, Ni—Co/Fe₂O₃, Ni—Mo/Fe₂O₃, Ni—Pt/MnO₂, Ni—Mo/MnO₂, Ni—Co/MnO₂, Ni/ZnO—Al₂O₃, Ni/Fe₂O₃—Al₂O₃, Ni/MnO₂—Al₂O₃.

Catalytically-active metal loading may vary from about 3 wt % to about 20 wt %. In a preferred embodiment, a first catalytically-active metal is loaded onto a metal oxide nanowire at a concentration of from about 3 wt % to about 20 wt %, and more preferably at a concentration of from about 6 wt % to about 15 wt %, and most preferably at a concentration of from about 12 wt %, and a second catalytically-active metal is loaded onto the metal oxide nanowire at a concentration of from about 0 wt % to about 12 wt %, and most preferably at a concentration of from about 6 wt %. In an exemplary embodiment, the first catalytically-active metal is nickel and the second catalytically active metal is selected from the group consisting of palladium, platinum, cobalt, molybdenum, copper, and combinations thereof.

Optionally, as is known in the art, a binder, such as alumina, bentonite clay or combinations thereof, may be added to the paste to improve crushing strength. In an exemplary embodiment, alumina is added to the composition at a concentration of from about 0 wt % to about 30 wt %.

The catalytically-active metal loaded metal oxide nanowire, or adsorbent, may be dried and formed into extrudates and calcined. Suitable drying temperatures will depend on the particular adsorbent, but a general range would be from about 100° C. to about 150° C., and preferably at about 120° C. Suitable calcining temperatures will depend on the particular adsorbent, but a general range would be from about 400° C. to about 500° C., and preferably at about 430° C. In a preferred embodiment, the extrudates are about 1.2 mm in diameter and about 1 cm in length, and the extruded adsorbent is calcined in a furnace at a temperature of from about 400° C. for a period of about 2 hours.

The adsorbent properties can be characterized by XRD, SEM, TEM, XPS and other known techniques. The BET surface area and pore volumes for some exemplary adsorbents are provided in Table 1 and FIG. 1 is a graph showing the X-ray diffraction patterns of some representative adsorbents.

TABLE 1
BET Surface area and pore volume of adsorbents

| | BET | *Pore | *Avg. |
|---|---|---|---|
| | S.A. | volume | pore |
| | (m² | (g_{cat} | size |
| Adsorbent + Binder | g_{cat}⁻¹) | cm⁻³) | (nm) |
| ZnO nanowires | 7.5 | 0.03 | 13.4 |
| 12% Ni—58.7% ZnO—29.3% Al₂O₃ | 109.7 | 0.26 | 6.7 |
| 6%Ni—6%Co—58.7% ZnO—29.3% Al₂O₃ | 99.3 | 0.21 | 5.9 |
| 6%Ni—6%Co—58.7% ZnO—29.3% Al₂O₃ | 92.9 | 0.2 | 6.1 |
| 12% Cu—58.7% ZnO—29.3% Al₂O₃ | 66.2 | 0.15 | 6.2 |
| 12% Ni—88% ZnO | 5.8 | 0.06 | 31.3 |
| 6% Ni—64.7% ZnO—29.3% Al₂O₃ | 47.7 | 0.14 | 7.8 |
| 12% Ni—68% ZnO—20% Al₂O₃ | 67.8 | 0.18 | 5.9 |
| 12% Ni—78% ZnO—10% Al₂O₃ | 18.9 | 0.09 | 2.1 |

The following examples are intended to provide the reader with a better understanding of the invention. The examples are not intended to be limiting with respect to any element not otherwise limited within the claims. For example, the present invention will be described in the context of zinc oxide nanowires, but the teachings herein are not limited to zinc oxide nanowires.

### Example 1

12% Ni—88% ZnO is prepared by dispersing 8.8 g of ZnO nanowires in distilled H₂O and subjecting the nanowires to sonication for about 5 minutes. An aqueous solution of 7.62 g nickel acetate tetrahydrate is then added dropwise while stirring and while maintaining the nanowire solution pH at 9.0 using NH₄OH solution. Stirring is continued for about 20 min after completion of addition and the nanowire nickel acetate solution is held in an oven at about 80° C. for approximately 15 hours. The oven temperature is then raised to about 150° C. and held at 150° C. for 3 h until a thick paste forms. The paste is then extruded and the extrudates are dried at about 150° C. for approximately 1 hour. The dried extrudates are then calcined at about 400° C. for approximately 2 h in static air.

### Example 2

12% Ni—58.7% ZnO—29.3% Al₂O₃ is prepared according to the method of Example 1 except 8.8 g of ZnO nanowires and 4.39 g of γ-Al₂O₃ powder are dispersed in distilled H₂O and the aqueous solution comprises 7.62 g nickel acetate.

### Example 3

12% Ni—58.7% ZnO—29.3% Al₂O₃ is prepared according to the method of Example 1 except the nickel acetate solution is adjusted to pH 9 with NH₄OH solution before addition to the nanowire solution.

### Example 4

6% Ni—6% Co—58.7% ZnO—29.3% Al₂O₃ is prepared according to the method of Example 1 except 8.8 g of ZnO nanowires and 4.39 g of γ-Al₂O₃ powder are dispersed in distilled H₂O and the aqueous solution comprises 3.81 g nickel acetate and 3.8 g of cobalt acetate tetrahydrate.

The adsorbents of the present invention are intended to be used in the vapor phase removal of sulfur from liquid fuels through a desulfurization process in a packed bed reactor with no external hydrogen supply. The desulfurization testing is done using a model hydrocarbon stream spiked with from about 100 ppm to about 500 ppm sulfur by weight with an assortment of refractory sulfur species to closely resemble industrial conditions. To perform the testing, fresh adsorbent—the metal coated nanowires—is packed into a stainless steel fixed bed reactor. To improve contact of the hydrocarbon feedstock that is to be subjected to desulfurization it is recommended that the adsorbents be extruded as particles with dimensions of about 1.2 mm diameter and a length of about 0.5 to about 1 cm.

The adsorbent is pretreated by heating the reactor to a temperature of about 150° C. and flowing nitrogen gas (N₂) over the adsorbent bed for about 2 hours and then reducing the adsorbent by starting a flow of hydrogen gas (H₂) over the adsorbent bed as the reactor temperature is raised over a period of about 2 hours from a temperature of about 150° C. at a temperature of about 430° C. and then holding the adsorbent bed at 430° C. with a H₂ gas flow for an additional 2 hours. Following pretreatment and reduction, the reactor temperature is cooled to a desulfurization temperature of 300° C. to about 425° C., more preferably at 350° C. to 400° C., and the hydrogen flow is stopped when the desired process temperature is reached.

A hydrocarbon feedstock then passes through the adsorbent at atmospheric pressure and at a liquid hourly space velocity of 0.5 h⁻¹ to 4 h⁻¹, more preferably at a liquid hourly space velocity of 1 h⁻¹ to 2 h⁻¹, most preferably at a liquid hourly space velocity of 1 h⁻¹. The hydrocarbon feedstock may be a sulfur containing liquid hydrocarbon, such as waste lube oil, transmix fuels, diesel fuel. To best replicate actual industrial conditions, the waste lube oil tested had a starting thiophenic sulfur concentration of from about 500 ppm to about 1500 ppm an including about 50 ppm to 100 ppm of refractory sulfur compounds such as benzothiophene, dibenzothiophene, 4,6-dimethyldibenzothiophene; the transmix fuels had a starting sulfur concentration of from about 1000 ppm to about 1500 ppm; and the diesel fuel had a starting sulfur concentration of from about 500 ppm to about 1500 ppm. The solid impurities are filtered off prior to desulfurization. In a preferred embodiment, a 2-stage process is used wherein the feedstock passes through the adsorbent in a first stage to reduce the sulfur level to less than about 200 ppm and then the reduced sulfur feedstock passes through a bed of fresh adsorbent a second time to further reduce the sulfur concentration.

### Example 5

15 g of the 12% Ni—58.7% ZnO—29.3% Al₂O₃ adsorbent from Example 3 is packed into a fixed bed reactor along with 5 g activated carbon and 5 g molecular sieves 13×, with the materials packed into the reactor such that the feedstock initially contacts the activated carbon and then the molecular sieves 13× and then the adsorbent, and then the feedstock exits the reactor. Prior to introduction of the feedstock, the adsorbent is pretreated and reduced, and the hydrogen gas flow is stopped. The reactor is then heated to a temperature of about 390° C. and atmospheric pressure. The hydrocarbon feedstock, a waste lube oil with 900 ppm sulfur, is preheated to vaporize the feedstock. The feedstock is pumped from a bottom inlet of the reactor and passes through the adsorbent at a liquid hourly space velocity of 1 to 3 h⁻¹ before exiting at a top outlet of the fixed bed reactor and condensing to a liquid. Table 2 shows the sulfur concentration from samples recovered at the outlet after various times on-stream.

TABLE 2

| Time on stream (h) | LHSV (h⁻¹) | Sulfur concentration at outlet (ppm) |
|---|---|---|
| 4.3 | 1 | 203.99 |
| 7.8 | 2 | 127.2 |
| 11.5 | 3 | 167.2 |

### Example 6

The feedstock exiting the outlet from Example 5 is then fed through fresh 12% Ni—58.7% ZnO—29.3% Al₂O₃ adsorbent in a reactor and under the same conditions as described in Example 5 to further reduce the sulfur concentration. Table 3 shows the sulfur concentration from samples recovered at the outlet after various times on-stream from this second-stage processing.

TABLE 3

| Time on stream (h) | LHSV (h⁻¹) | Sulfur concentration at outlet (ppm) |
|---|---|---|
| 3.5 | 2 | 53.5 |
| 12.2 | 1 | 67 |
| 14.5 | 1 | 76 |
| 6.6 | 0.5 | 58.5 |
| 18.7 | 0.5 | 43.8 |
| 25.2 | 0.5 | 47 |

### Example 7a

Example 5 is repeated with 17.5 g of the 12% Ni—58.7% ZnO—29.3% Al₂O₃ adsorbent, and the waste lube oil feedstock is replaced with a diesel feed obtained from a local gas station spiked to 470 ppm sulfur with 95% thiophene and 5% a combination of benzothiophene (BT), dibenzothiophene (DBT), 4,6-dimethyldibenzothiophene (DMDBT), and 4-methyldibenzothiophene (MDBT). More than 95% of thiophenes and benzothiophenes are removed during 48 hours of operation.

### Example 7b

Example 7a is repeated with 17.5 g of the 6% Ni—6% Mo—58.7% ZnO—29.3% Al₂O₃ adsorbent, and the waste lube oil feedstock is replaced with a diesel feed obtained from a local gas station spiked to 470 ppm sulfur with 95% thiophene and 5% a combination of benzothiophene (BT), dibenzothiophene (DBT), 4,6-dimethyldibenzothiophene (DMDBT), and 4-methyldibenzothiophene (MDBT). More than 95% of thiophenes and benzothiophenes are removed during 24 hours of operation.

### Example 8

Example 5 is repeated except 30 g of the 12% Ni—58.7% ZnO—29.3% Al₂O₃ adsorbent containing 15 wt % alumina binder is used. The waste lube oil with 900 ppm sulfur is vaporized and passes through the adsorbent at a liquid hourly space velocity of 0.5 h⁻¹ before exiting at a top outlet of the fixed bed reactor and condensing to a liquid. Table 4 shows the sulfur concentration from samples recovered at the outlet after various times on-stream.

TABLE 4

| Time on stream (h) | LHSV (h⁻¹) | Sulfur concentration at outlet (ppm) |
|---|---|---|
| 18 | 0.5 | 58.5 |
| 31.2 | 0.5 | 51.4 |
| 42.3 | 0.5 | 43.8 |

### Example 9

Example 5 is repeated except the 5 g activated carbon and 5 g molecular sieves 13× are replaced with Selexsorb® with ⅛″ diameter spheres from BASF, and the waste lube oil feedstock is replaced with terapure oil (T-120) oil with 900 ppm sulfur and the feedstock passes through the adsorbent at a liquid hourly space velocity of 1 h⁻¹. Table 5 shows the sulfur concentration from samples recovered at the outlet after various times on-stream.

TABLE 5

| Time on stream (h) | LHSV (h⁻¹) | Sulfur concentration at outlet (ppm) |
|---|---|---|
| 4 | 1 | 263.602 |
| 6.333 | 1 | 61.184 |
| 11.683 | 1 | 13.565 |
| 23.750 | 1 | 19.625 |
| 32.167 | 1 | 27.860 |

The metal oxide nanowires with the catalytically-active metal particles of the present invention are intended to be used in a desulfurization process without adding external hydrogen. The use of nanowire-structured adsorbents is expected to result in improved mass-transfer and an improved mechanical behavior during high temperature operation. Further, these nanowires are expected to offer rapid reaction rates that overcome the diffusion limitations of conventional pellet-based adsorbents and allow all of the material to be used efficiently. It is anticipated that the adsorbents of the present invention may be used in the desulfurization of hydrocarbon fuels commonly found in the oil refining including, but not limited to, waste lube oil, light cycle oil, diesel, jet fuel, kerosene, and combinations thereof.

Unless defined otherwise, all technical and scientific terms used herein have the same meaning as commonly understood by one of ordinary skill in the art to which the presently disclosed subject matter pertains. Representative methods, devices, and materials are described herein, but are not intended to be limiting unless so noted.

The terms “a”, “an”, and “the” refer to “one or more” when used in the subject specification, including the claims. The term “ambient temperature” as used herein refers to an environmental temperature of from about 0° F. to about 120° F., inclusive.

Unless otherwise indicated, all numbers expressing quantities of components, conditions, and otherwise used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed application.

All compositional percentages used herein are presented on a “by weight” basis, unless designated otherwise. Specific compositions relevant to the titanium(IV) oxide nanowires with catalytically-active metal sulfide particles composition are provided herein for the purpose of demonstrating the invention, but these compositions are not intended to limit the scope of the invention. It is understood that one skilled in the art may make alterations to the embodiments shown and described herein without departing from the scope of the invention.

What is claimed is:

1. A composition for an adsorbent for removal of thiophenic sulfur from liquid fuels, wherein the adsorbent comprises a metal oxide nanowire decorated with catalytically-active metals selected from the group consisting of nickel, cobalt, molybdenum, platinum, palladium, copper and a combination thereof.

2. The adsorbent of claim 1 wherein the metal oxide nanowire comprises zinc oxide, iron oxide, manganese oxide, or a combination thereof.

3. The adsorbent of claim 2 wherein the metal oxide nanowire concentration is from about 55 wt % to about 88 wt %.

4. The adsorbent of claim 1 wherein the catalytically-active metal loading is from about 3 wt % to about 20 wt %.

5. The adsorbent of claim 3 wherein a first catalytically-active metal is loaded onto the nanowire at a concentration of from about 3 wt % to about 20 wt %, and a second catalytically-active metal is loaded onto a nanowire at a concentration of from about 0 wt % to about 12 wt %.

6. The adsorbent of claim 1 further comprising a binder, selected from the group consisting of alumina, bentonite clay and combinations thereof.

7. The adsorbent of claim 5 wherein the binder comprises from about 0 wt % to about 30 wt % of the composition.

8. A composition for an adsorbent wherein the adsorbent comprises a metal oxide nanowire selected from zinc oxide, iron oxide, manganese oxide, or a combination thereof, decorated with catalytically-active metals selected from the group consisting of nickel, cobalt, molybdenum, platinum, palladium, copper and a combination thereof.

9. The adsorbent of claim 8 further comprising a binder, selected from the group consisting of alumina, bentonite clay and combinations thereof.

10. The adsorbent of claim 8 wherein the metal oxide nanowire concentration is from about 55 wt % to about 88 wt %.

11. The adsorbent of claim 8 wherein the catalytically-active metal loading is from about 3 wt % to about 20 wt %.

12. The adsorbent of claim 11 wherein a first catalytically-active metal is loaded onto the nanowire at a concentration of from about 3 wt % to about 20 wt %, and a second catalytically-active metal is loaded onto a nanowire at a concentration of from about 0 wt % to about 12 wt %.

13. The adsorbent of claim 9 wherein the binder comprises from about 0 wt % to about 30 wt % of the composition.

14. An adsorbent comprising a metal oxide nanowire selected from zinc oxide, iron oxide, manganese oxide, or a combination thereof, decorated with catalytically-active metals selected from the group consisting of nickel, cobalt, molybdenum, platinum, palladium, copper and a combination thereof, wherein the adsorbent is used for the vapor phase removal of sulfur from liquid fuels in a desulfurization process with no external hydrogen supply and wherein the adsorbent reduces the sulfur level to less than about 200 ppm.

15. The adsorbent of claim 14 wherein the catalytically-active metal is an elemental metal or a metal oxide.

16. The adsorbent of claim 14 further comprising a binder, selected from the group consisting of alumina, bentonite clay and combinations thereof.

17. The adsorbent of claim 14 wherein the metal oxide nanowire concentration is from about 55 wt % to about 88 wt %.

18. The adsorbent of claim 14 wherein the catalytically-active metal loading is from about 3 wt % to about 20 wt %.

19. The adsorbent of claim 14 wherein a first catalytically-active metal is loaded onto the nanowire at a concentration of from about 3 wt % to about 20 wt %, and a second catalytically-active metal is loaded onto a nanowire at a concentration of from about 0 wt % to about 12 wt %.

20. The adsorbent of claim 16 wherein the binder comprises from about 0 wt % to about 30 wt % of the composition.

21. The adsorbent of claim 14 wherein the adsorbent is pretreated by heating the adsorbent in a reactor to a temperature of about 150° C. and flowing nitrogen gas (N₂) over the adsorbent for about 2 hours and then reducing the adsorbent by starting a flow of hydrogen gas (H₂) over the adsorbent as the reactor temperature is raised over a period of about 2 hours from a temperature of about 150° C. at a temperature of about 430° C. and then holding the adsorbent at 430° C. with a H₂ gas flow for an additional 2 hours, and then cooling the reactor to a desulfurization temperature of 300° C. to about 425° C. and stopping the hydrogen gas flow when the desired process temperature is reached.

22. The adsorbent of claim 14 wherein the sulfur in the liquid fuel is benzothiophene, dibenzothiophene, 4,6-dimethyldibenzothiophene, or a combination thereof.
